(19) United States
(12) Patent Application Publication
(10) Pub. No.: US 2025/0264352 A1
(43) Pub. Date: Aug. 21, 2025

(54) Method to measure levels at a vessel outlet and pivotable sensor to carry out the method

(71) Applicant: LJ Star, Inc., Twinsburg, OH (US)

(72) Inventors: Daniel Turner Klees, Penfield, NY (US); Jacob Andrew Ramey, Akron, OH (US)

(73) Assignee: LJ Star, Inc., Twinsburg, OH (US)

(21) Appl. No.: 18/857,039

(22) PCT Filed: May 9, 2023
(86) PCT No.: PCT/US2023/066768

§ 371 Date: Oct. 15, 2024

Related U.S. Application Data
(60) Provisional application No. 63/497,828, filed on Apr. 24, 2023.
(60) Provisional application No. 63/364,351, filed on May 9, 2022.

(51) Int. Cl. G01F 23/292; G01S 7/02; G01S 13/42

(52) U.S. Cl. CPC G01F 23/292; G01S 7/027; G01S 13/426

(57) ABSTRACT

A method of measuring the liquid level at a vessel outlet connection located on an outlet side of a vessel comprises directing an incident beam through a vessel connection located on the top head of the vessel opposite the outlet side of the vessel so that an incident beam line forms an acute angle with the vessel outlet connection longitudinal axis. An apparatus for carrying out the method is configured to allow the incident beam line to pivot +/−30 degrees from the vessel connection longitudinal axis and to allow the incident beam line to rotate about the vessel connection longitudinal axis.

### CROSS REFERENCES AND PRIORITIES

This application claims priority from U.S. provisional applications Nos. 63/634,351 filed 9 May 2022 and 63/497,828 filed on 24 Apr. 2023, the teachings of which both are incorporated in their entirety herein.

### BACKGROUND

Many manufacturing processes—such as manufacturing of beverages, pharmaceuticals, and other liquid products—occur within a vessel having a vessel connection mounted on the top head of the vessel and a vessel outlet connection located at the low point in the vessel bottom head. Often the vessel outlet connection is located at or near the bottom of a vessel with the vessel having a conical, concave, or otherwise angled bottom wall which directs liquid products in the vessel towards the vessel outlet, allowing for complete vessel draining.

In monitoring the manufacturing process it is often important to determine the liquid level inside of the vessel. Often this is achieved using a radar level measurement device. The radar level measurement device bounces a microwave electromagnetic signal off the liquid surface and measures the time necessary for the signal to travel to the liquid surface and return to the radar level measurement device. Knowing the vessel geometry, it is then possible to accurately calculate the liquid level in the vessel.

Typically the radar level measurement device will be mounted at or near the top of the vessel on a vessel connection. In many instances when it is necessary to measure the minimal holdup liquid level above the vessel outlet connection, it is not possible to mount the radar level measurement device directly above the vessel outlet connection. This can result in inaccurate liquid level measurements at the vessel outlet—particularly when the vessel has a conical, concave, or otherwise angled bottom wall.

Further complications arise from the need to maintain sealing—including aseptic sealing—of the vessel, from the need to maintain pressure and temperature during the manufacturing process, and from the need to isolate and protect the radar sensor from the process material. These factors may be solved with the use of an appropriate process flow sight glass, and accordingly, the vessel connection intended as the mount for the radar level measurement device may be covered with a process flow slight glass during operation. One example of such a process flow sight glass—which forms an aseptic seal with the vessel connection—is disclosed in U.S. Pat. No. 10,914,910 B2—the teachings of which are incorporated by reference herein in their entirety. In such devices, it may be necessary to connect the radar level measurement device to the process flow sight glass to maintain sealing—such as aseptic sealing—between the vessel connection and the process flow sight glass, and to maintain pressure and temperature during the manufacturing process, while enabling liquid level measurement and protecting the sensor

The need exists, therefore, for an improved apparatus and method for measuring the liquid level above a vessel low point outlet which maintains sealing at the vessel connection in the top of the vessel and more accurately measures liquid level above the vessel low point outlet connection.

### SUMMARY

Described herein is a method of measuring liquid level above a vessel outlet connection located on an outlet side of a vessel having a vessel outlet connection longitudinal axis with a sensor that emits an incident beam which forms an incident beam line. The method may comprise directing the incident beam through a vessel connection located on a side of the vessel opposite the outlet side and having a vessel connection longitudinal axis so that the incident beam line so that the incident beam line and the vessel outlet connection longitudinal axis form an acute angle having a degree value in range of 1 Degree to the Degree value when the incident beam line intersects the vessel outlet connection longitudinal axis at the vessel outlet connection.

Also described herein is an apparatus for carrying out the method. The apparatus may be configured to allow the incident beam line to pivot +/−30 degrees from the vessel connection longitudinal axis forming a first angle relative to the vessel connect longitudinal axis. The apparatus may also be configured so that the incident beam line can be rotated about the vessel connection longitudinal axis.

In a first embodiment of the apparatus, the apparatus may comprise an apparatus base, a rotation member, and a pivot member. The apparatus base may be configured to connect to the vessel connection. The rotation member may comprise an incident beam hole, at least one rotation member mounting hole, and at least one rotation member curvilinear slot. The pivot member may comprise a pivot member housing and a sensor housing. The pivot member housing may comprise a first hemispherical exterior profile, a pivot member housing through hole around a pivot member housing longitudinal axis, at least one pivot member housing longitudinal mounting hole, at least one pivot member housing radial mounting hole, and at least one pivot member housing curvilinear slot. The sensor housing may comprise a second hemispherical exterior profile, a sensor housing through hole passing around a sensor housing longitudinal axis, and at least a sensor housing first mounting hole and a sensor housing second mounting hole.

In the first embodiment, the rotation member may be configured to connect to the apparatus base by passing a first fastener through at least one rotation member mounting hole and into at least one apparatus base mounting hole. The pivot member housing may be configured to connect to the rotation member by passing a second fastener through the at least one pivot member housing longitudinal mounting hole and the at least one rotation member curvilinear slot. The pivot member housing may be configured to connect to the sensor housing by passing a third fastener through the pivot member housing radial mounting hole and into the sensor housing first mounting hole, and passing a fourth fastener through the pivot member housing curvilinear slot and into the sensor housing second mounting hole. A hemispherical interior profile of the pivot member housing may be configured to interface with the second hemispherical exterior profile. The sensor may be configured to reside at least partially within a pivot member longitudinal hole formed by the pivot member housing through hole and the sensor housing through hole.

In some embodiments of the first embodiment the apparatus base may be configured to connect to the vessel connection by a clamp. In certain embodiments, a first gasket may be configured to locate at an interface between the apparatus base and the vessel connection. In some embodiments, the apparatus base may be a process flow sight glass.

In certain embodiments of the first embodiment the apparatus may further comprise a second gasket configured to locate at an interface between the rotation member and the apparatus base. In some embodiments, the apparatus may further comprise a third gasket located at an interface between the pivot member and the rotation member.

In a second embodiment of the apparatus, the apparatus may comprise an apparatus base and a pivot member. The apparatus base may be configured to connect to the vessel connection. The pivot member may comprise a pivot member casing and a sensor casing. The pivot member casing may comprise a bottom wall, a first side wall extending upwardly from a bottom wall first edge and having a first concave interior surface, a second side wall extending upwardly from a bottom wall second edge opposite the bottom wall first edge and having a second concave interior surface, a pivot member casing mounting hole parallel with the bottom wall first edge and the bottom wall second edge, and a pivot member casing through hole around a pivot member casing longitudinal axis. The sensor casing may comprise a sensor casing planar member having at least a first edge and a second edge, a sensor casing extension, a sensor casing mounting hole passing through a tip of the sensor casing extension, and a sensor casing through hole around a sensor casing longitudinal axis.

In the second embodiment, the apparatus base may comprise a clamp having at least one stud extending from a clamp top surface. The pivot member casing may be configured to connect to the apparatus base by passing a third fastener through the stud and the sensor casing mounting hole. The sensor casing may be configured to connect to the pivot member casing by passing the third fastener through the pivot member casing mounting hole and the sensor casing mounting hole. The first concave interior surface may be configured to interact with the first edge. The second concave interior surface may be configured to interact with the second edge. The sensor may be configured to reside at least partially within a pivot member longitudinal hole formed by the pivot member casing through hole and the sensor casing through hole.

In some embodiments of the second embodiment, the apparatus base may be configured to connect to the vessel connection by a clamp. In certain embodiments, a first gasket may be configured to locate at an interface between the apparatus base and the vessel connection. In some embodiments, the apparatus base may be a process flow sight glass.

In certain embodiments of the second embodiment, the apparatus may further comprise a fourth gasket configured to locate at an interface between the pivot member casing and the apparatus base. In some embodiments, the sensor casing extension may have a substantially triangular shape.

In a third embodiment of the apparatus, the apparatus may comprise an apparatus base and an axis adjustment member. The apparatus base may be configured to connect to the vessel connection. The axis adjustment member may comprise a ball and a mounting clamp. The ball may have an axial through hole. The mounting clamp may comprise a first mounting clamp section and a second mounting clamp section. The first mounting clamp section may have a first concave surface, a first mounting clamp section mounting surface, and a first mounting clamp section through hole around a first mounting clamp section longitudinal axis. The second mounting clamp section may have a second concave surface, and a second mounting clamp section through hole around a second mounting clamp section longitudinal axis.

In the third embodiment, the axis adjustment member may be configured to connect to the apparatus base with the first mounting clamp section mounting surface abutting against a planar surface of the apparatus base. The ball may be configured to reside within an interior of the mounting clamp formed by the first concave surface and the second concave surface. The sensor may be configured to reside at least partially within the axial through hole.

In some embodiments of the third embodiment, the apparatus base may be configured to connect to the vessel connection by a clamp. In certain embodiments, a first gasket may be configured to locate at an interface between the apparatus base and the vessel connection. In some embodiments, the apparatus base may be a process flow sight glass.

In certain embodiments of the third embodiment, the apparatus may further comprise a fourth gasket configured to locate at an interface between the first mounting section mounting surface and the apparatus base.

### BRIEF DESCRIPTION OF FIGURES

FIG. 1 depicts prior art principles of operation of method for measuring the liquid level within a vessel.

FIG. 2 depicts principles of operation of the invented apparatuses and method for measuring the liquid level above a vessel outlet connection located at the low point in the vessel bottom head.

FIG. 3 is a perspective view of one embodiment of an apparatus for measuring the liquid level above a vessel outlet connection located at the low point in the vessel bottom head.

FIG. 4 is an exploded side view of the embodiment of an apparatus for measuring the liquid level above a vessel outlet connection of FIG. 3.

FIG. 5 is an axial cross-section view of the embodiment of an apparatus for measuring the liquid level above a vessel outlet connection of FIG. 3.

FIG. 6 is a perspective view of another embodiment of an apparatus for measuring the liquid level above a vessel outlet connection located at the low point in the vessel bottom head.

FIG. 7 is partially transparent perspective of the embodiment of an apparatus for measuring the liquid level above a vessel outlet connection of FIG. 6.

FIG. 8 is an axial cross-section view of the embodiment of an apparatus for measuring the liquid level above a vessel outlet connection of FIG. 6.

FIG. 9 is an exploded side view of another embodiment of an apparatus for measuring the liquid level above a vessel outlet connection located at the low point in the vessel bottom head.

FIG. 10 is an axial cross-section view of the embodiment of an apparatus for measuring the liquid level above a vessel outlet connection of FIG. 9.

FIG. 11 is a plot of the measured level and actual level at various acute angles of the incident beam line.

FIG. 12 is an enlarged plot of the measured level and actual level at various acute angles of the incident beam line.

### DETAILED DESCRIPTION

Disclosed herein are apparatuses and a method for measuring the liquid level above a vessel outlet connection. The apparatuses and method are described below with reference to the Figures. As described herein and in the claims, the following numbers refer to the following structures as noted in the Figures.
100 refers to a vessel.
110 refers to a vessel connection.
112 refers to a first flange.
114 refers to a pivot axis.
116 refers to a vessel connection longitudinal axis.
120 refers to a vessel outlet connection.
125 refers to a vessel outlet connection longitudinal axis.
200 refers to an apparatus base.
210 refers to a first fastener.
220 refers to an apparatus base mounting hole.
230 refers to a clamp.
240 refers to a first gasket.
250 refers to a stud.
300 refers to a rotation member.
310 refers to an incident beam hole.
320 refers to a rotation member mounting hole.
330 refers to a rotation member curvilinear slot.
340 refers to a second fastener.
350 refers to a second gasket.
400 refers to a pivot member.
410 refers to a pivot member housing.
411 refers to a first hemispherical exterior profile.
412 refers to a pivot member housing through hole.
413 refers to a pivot member housing longitudinal axis.
414 refers to a pivot member housing longitudinal mounting hole.
415 refers to a pivot member housing radial mounting hole.
416 refers to a pivot member housing curvilinear slot.
420 refers to a sensor housing.
421 refers to a second hemispherical exterior profile.
422 refers to a sensor housing through hole.
423 refers to a sensor housing longitudinal axis.
424 refers to a sensor housing first mounting hole.
425 refers to a sensor housing second mounting hole.
430 refers to a third fastener.
440 refers to a fourth fastener.
450 refers to a pivot member longitudinal hole.
460 refers to a third gasket.
470 refers to a pivot member casing.
471 refers to a bottom wall.
472 refers to a first side wall.
473 refers to a bottom wall first edge.
474A refers to a first concave interior surface.
474B refers to a second concave interior surface.
475 refers to a second side wall.
476 refers to a bottom wall second edge.
477 refers to a pivot member casing mounting hole.
478 refers to a pivot member casing through hole.
479 refers to a pivot member casing longitudinal axis.
480 refers to a sensor casing.
481 refers to a sensor casing planar member.
482 refers to a first edge (of the sensor casing planar member).
483 refers to a second edge (of the sensor casing planar member).
484 refers to a sensor casing extension.
485 refers to a sensor casing mounting hole.
486 refers to a tip (of the sensor casing extension).
487 refers to a sensor casing through hole.
488 refers to a sensor casing longitudinal axis.
500 refers to a sensor.
510 refers to an incident beam.
520 refers to an incident beam line.
600 refers to an axis adjustment member.
610 refers to a ball.
615 refers to an axial through hole.
620 refers to a mounting clamp.
621 refers to a first mounting clamp section.
622 refers to a second mounting clamp section.
623 refers to a first concave surface.
624 refers to a first mounting clamp section mounting surface.
625 refers to a first mounting clamp section through hole.
626 refers to a first mounting clamp section longitudinal axis.
627 refers to a second concave surface.
628 refers to a second mounting clamp section through hole.
629 refers to a second mounting clamp section longitudinal axis.
θ refers to an acute angle formed by the incident beam line and the vessel connection longitudinal axis.

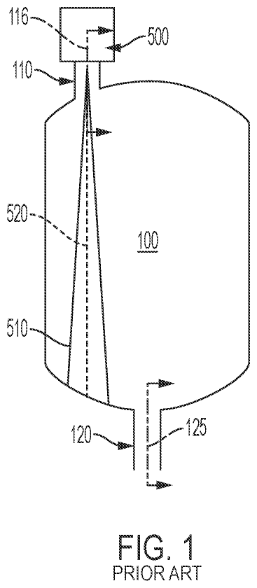

FIG. 1 depicts the principles of operation of a prior art method and apparatus for measuring liquid level in a vessel (100). As shown in FIG. 1, in the prior art, a sensor (500)—sometimes referred to as a radar level measurement device—is mounted to the vessel connection (110) on the top head of the vessel. The sensor emits a microwave electromagnetic signal—referred to herein as an incident beam (510)—into the vessel interior. When the incident beam reaches the liquid surface, it is reflected from the liquid surface and returns to the sensor. The sensor can then determine the liquid level by measuring the time that it took for the incident beam to travel from the sensor to the liquid surface and return to the sensor. One example of such a sensor is a VEGAPULS® 64 radar level sensor available from VEGA Americas, Inc. of Cincinnati, OH, U.S.A.

As shown in FIG. 1, the incident beam (510) travels along an incident beam line (520). In many instances—such as that shown in FIG. 1—the incident beam line does not intersect the vessel outlet connection longitudinal axis (125). When the vessel has a conical, concave, or otherwise angled bottom wall with the vessel outlet connection located at or near the bottom of the vessel, this can lead to inaccurate measurement of the liquid level at the vessel outlet connection as the incident beam only encounters the liquid surface at a point within the vessel that is not aligned with the vessel outlet connection longitudinal axis.

The wavelength of the microwave electromagnetic signal is preferably in the range of 0.03 cm to 30 cm, with the range of 0.8 cm to 10.0 cm corresponding to the range of radar electromagnetic signal more preferred.

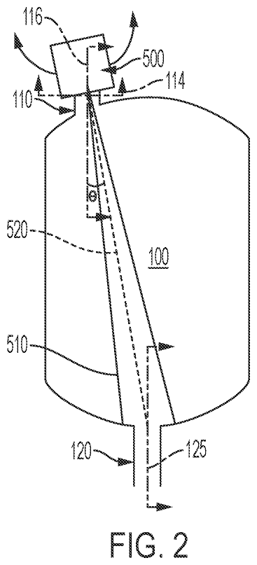

FIG. 2 depicts the principles of operation of an invented method and apparatus for measuring liquid level in a vessel (100). As shown in FIG. 2, the sensor (500) is adjustably mounted to the vessel connection (110) located in the top head of the vessel. The sensor may then be rotated about the vessel connection longitudinal axis (116) and/or pivoted about a pivot axis (114) orthogonal to the vessel connection longitudinal axis to direct the incident beam (510) through the vessel connection so that the incident beam line (520) intersects both the vessel connection longitudinal axis and the vessel outlet connection longitudinal axis (125) at the vessel outlet connection (120).

As shown in FIG. 2, the incident beam line and the vessel outlet connection longitudinal axis form an acute angle (θ). This acute angle has a degree value in range of 1 Degree and the Degree value when the incident beam line intersects with the vessel outlet connection longitudinal axis at the vessel outlet connection. This is so described because the maximum angle will vary with vessel dimensions.

Directing the incident beam (510) through the vessel connection (110) as described herein and shown in FIG. 2 may be achieved by connecting an apparatus to the vessel connection which allows the incident beam line (520) to rotate +/−30 degrees about the vessel connection longitudinal axis (116) as shown in FIG. 2. This forms a first angle of the incident beam line relative to the vessel connection longitudinal axis.

Additionally, as shown in FIG. 2, the apparatus may also be configured so that the incident beam line (520) can be pivoted about a pivot axis (114) orthogonal to the vessel connection longitudinal axis (116). This allows the incident beam (510) to be more accurately directed to intersect with the vessel outlet connection longitudinal axis (125) once the incident beam line has been pivoted.

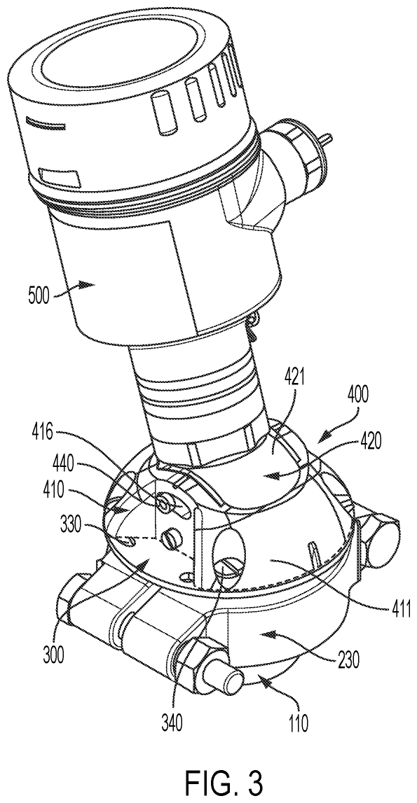

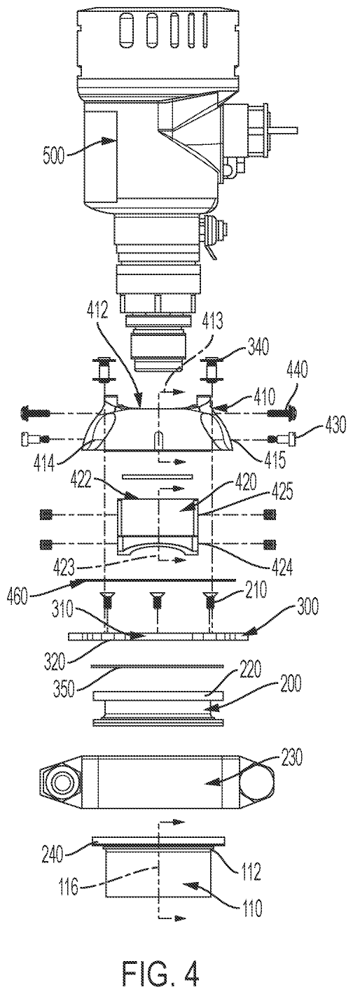

The apparatus may come in many different embodiments and configurations. One embodiment is shown in FIG. 3 to FIG. 5 and described herein. FIG. 3 shows this embodiment in perspective view with the apparatus comprising an apparatus base (200 as shown in FIG. 4), a rotation member (300), and a pivot member (400).

Generally, the apparatus base (200) will be configured to connect to the vessel connection (110). The connection between the vessel connection and the apparatus base may take many forms. In some embodiments, the connection between the vessel connection and the apparatus base may comprise a threaded connection in which the apparatus base threads onto or into the vessel connection. In other embodiments, the connection between the vessel connection and the apparatus base may comprise the use of at least one fastener such as a clamp, a screw, a bolt, and combinations thereof. Often a first gasket (240) will be located at an interface between the apparatus base and the vessel connection to improve sealing between the vessel connection and the apparatus base.

In some embodiments, the apparatus base (200) may be a process flow sight glass. One example of such a process flow sight glass—which forms an aseptic seal with the vessel connection—is disclosed in U.S. Pat. No. 10,914,910 B2—the teachings of which are incorporated by reference herein in their entirety. As discussed in U.S. Pat. No. 10,914,910 B2, the process flow sight glass may be connected to the vessel connection by way of a clamp (230) of the type disclosed in U.S. Pat. No. 10,914,910 B2. The optically transparent portion of the sight glass is also transparent to the radar waves. Fused glass is preferred, particularly borosilicate as opposed to soda-lime.

The process flow sight glass has also been designed to use a plastic such as polyether ether ketone (PEEK) instead of glass. The key operating issue is that the plastic be chosen to be at least 50% transparent to the microwave electromagnetic wavelength in the range of 0.03 cm to 30 cm, or more preferably 0.8 cm to 10 cm.

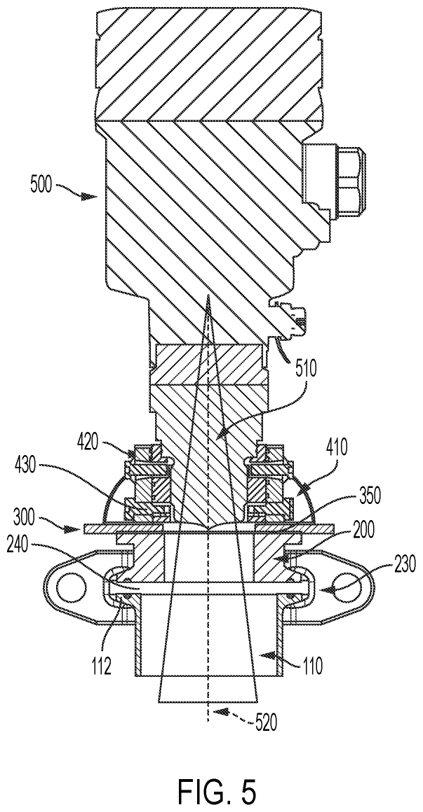

FIG. 3 shows the rotation member (300) of the first embodiment of an apparatus. As shown in FIG. 3, the rotation member comprises an incident beam hole (310 as shown in FIG. 4) allowing the incident beam (510 as shown in FIG. 5) to pass through the rotation member and into the vessel (100 as shown in FIG. 2) when the apparatus is connected to the vessel connection (110). The rotation member also comprises at least one rotation member mounting hole (320 as shown in FIG. 4), and at least one rotation member curvilinear slot (330 as shown in FIG. 3). In practice, the number of rotation member mounting hole(s) and rotation member curvilinear slot(s) is not considered important. Generally, the number of rotation member mounting hole(s) may be an integer in the range of between 1 and 10. Similarly, the number of rotation member curvilinear slot(s) may be an integer in the range of between 1 and 10.

FIG. 3 further shows the pivot member (400) of the first embodiment of an apparatus. As shown in FIG. 3, the pivot member comprises a pivot member housing (410) and a sensor housing (420). In general, the pivot member housing will be configured to encompass the sensor housing with the sensor housing residing within a hollow interior of the pivot member housing.

The pivot member housing (410) may have an exterior profile which is generally hemispherical (referred to herein as a first hemispherical exterior profile (411)). A pivot member housing through hole (412 as shown in FIG. 4) may pass through a pivot member housing longitudinal axis (413 as shown in FIG. 4) allowing at least a portion of the sensor (500) to reside within the pivot member housing. This pivot member housing through hole (412) may have an interior profile which is generally round.

The pivot member housing (410) may also comprise at least one pivot member housing longitudinal mounting hole (414 as shown in FIG. 4), at least one pivot member housing radial mounting hole (415 as shown in FIG. 4), and at least one pivot member housing curvilinear slot (416) as shown in FIG. 3. The pivot member housing longitudinal mounting hole(s) may be substantially aligned or aligned with a longitudinal axis of the pivot member allowing the pivot member housing to connect to the rotation member (300) as described herein. The pivot member housing radial mounting hole(s) may be substantially aligned or aligned with a radial axis of the pivot member allowing the pivot member housing to connect to the sensor housing as described herein. When the pivot member housing is connected to the sensor housing, the pivot member housing radial mounting hole(s)—along with the sensor housing first mounting hole(s) (424 as shown in FIG. 4) described herein—serve as a pivot point allowing the incident beam (510 as shown in FIG. 5) to pivot from the vessel connection longitudinal axis (116 as shown in FIG. 4). The pivot member housing curvilinear slot(s) may also be substantially aligned or aligned with the radial axis of the pivot member and serve to further connect the pivot member housing to the sensor housing as described herein.

In practice, the number of pivot member housing longitudinal mounting hole(s) (414), pivot member housing radial mounting hole(s) (415), and pivot member housing curvilinear slot(s) (416) is not considered important. Generally, the number of pivot member longitudinal mounting hole(s) may be an integer in the range of between 1 and 10. Similarly, the number of pivot member housing radial mounting hole(s) may be an integer in the range of between 1 and 2. When the number of pivot member housing radial mounting holes is 2, the longitudinal axis of each of the pivot member radial mounting holes will preferably be aligned with one another. Also, the number of pivot member housing curvilinear slot(s) may be an integer in the range of between 1 and 2. When the number of pivot member housing curvilinear slots is 2, the longitudinal axis of each of the pivot member curvilinear slots will preferably be aligned with one another.

FIG. 3 also shows the sensor housing (420). As shown in FIG. 3, the sensor housing may have an exterior profile which is generally hemispherical (referred to herein as a second hemispherical exterior profile (421)). This second hemispherical exterior profile (421) may be constructed to interface with the hemispherical interior profile of the pivot member housing (410). In some embodiments, an O-ring, gasket, or other sealing member may be located at or about at least a portion of the interface between the sensor housing and the pivot member housing. A sensor housing through hole (422 as shown in FIG. 4) may pass around a sensor housing longitudinal axis (423 as shown in FIG. 4) allowing a portion of the sensor (500) to reside within the sensor housing.

The sensor housing (420) may also comprise at least a sensor housing first mounting hole (424) and a sensor housing second mounting hole (425) as shown in FIG. 4. Each of the sensor housing first mounting hole(s) and the sensor housing second mounting hole(s) may be substantially aligned or aligned with a radial axis of the sensor housing allowing the pivot member housing to connect to the sensor housing as described herein.

In practice, the number of sensor housing first mounting hole(s) (424) and sensor housing second mounting hole(s) (425) is not considered important. Generally, the number of sensor housing first mounting hole(s) may be an integer in the range of between 1 and 2. Similarly, the number of sensor housing second mounting hole(s) may be an integer in the range of between 1 and 2. Preferably, the number of sensor housing first mounting hole(s) will equal the number of pivot member housing radial mounting hole(s) (415). When the number of sensor housing first mounting holes is 2, the longitudinal axis of each of the sensor housing first mounting hole(s) will preferably be aligned with one another. Preferably, the number of sensor housing second mounting hole(s) will equal the number of pivot member housing curvilinear slot(s) (416). When the number of sensor housing second mounting holes is 2, the longitudinal axis of each of the sensor housing second mounting hole(s) will preferably be aligned with one another.

As shown in FIG. 3 through FIG. 5, the rotation member (300) may be configured to connect to the apparatus base (200) by passing a first fastener (210) through at least one rotation member longitudinal mounting hole (320) and into at least one apparatus base mounting hole (220). In embodiments comprising more than one rotation member longitudinal mounting hole and more than one apparatus base mounting hole, there may be a plurality of first fasteners with each individual first fastener passing through one of the rotation member longitudinal mounting holes and into a corresponding apparatus base mounting hole. Each first fastener may individually be selected from the group of fasteners consisting of a bolt, a screw, a rivet, and the like. In some embodiments, each first fastener may include an O-ring, gasket, or other sealing member. Preferably, a second gasket (350) will be located at an interface between the rotation member and the apparatus base when the rotation member is connected to the apparatus base.

FIG. 3 through FIG. 5 also show the pivot member housing (410) which may be configured to connect to the rotation member by passing a second fastener (340) through the at least one pivot member housing longitudinal mounting hole (414) and the at least one rotation member curvilinear slot (330). In embodiments comprising more than one pivot member housing longitudinal mounting hole and more than one rotation member curvilinear slot, there may be a plurality of second fasteners with each individual second fastener passing through one of the pivot member housing longitudinal mounting holes and into a corresponding rotation member curvilinear slot. Each second fastener may individually be selected from the group of fasteners consisting of a bolt, a screw, a rivet, and the like. In some embodiments, each second fastener may include an O-ring, gasket, or other sealing member. Preferably, a third gasket (460) will be located at an interface between the pivot member and the rotation member when the pivot member is connected to the rotation member.

Further shown in FIG. 3 through FIG. 5 is the pivot member housing (410) which may be configured to connect to the sensor housing (420) by passing a third fastener (430) through the at least one pivot member housing radial mounting hole (415) and into the at least one sensor housing first mounting hole (424), and passing a fourth fastener (440) through the at least one pivot member housing curvilinear slot (416) and into the at least one sensor housing second mounting hole (425). In embodiments comprising more than one pivot member housing radial mounting hole and more than one sensor housing first mounting hole, there may be a plurality of third fasteners with each individual third fastener passing through one of the pivot member housing radial mounting holes and into a corresponding sensor housing first mounting hole. Similarly, in embodiments comprising more than one pivot member housing curvilinear slot and more than one sensor housing second mounting hole, there may be a plurality of fourth fasteners with each individual fourth fastener passing through one of the pivot member housing curvilinear slots and into a corresponding sensor housing second mounting hole. Each third fastener may individually be selected from the group of fasteners consisting of a bolt, a screw, a rivet, and the like. In some embodiments, each third fastener may include an O-ring, gasket, or other sealing member. Similarly, each fourth fastener may individually be selected from the group of fasteners consisting of a bolt, a screw, a rivet, and the like. In some embodiments, each fourth fastener may include an O-ring, gasket, or other sealing member.

Once assembled, the sensor (500) may be connected to the apparatus as shown in FIG. 5. The sensor may be connected to the apparatus by passing a portion of the sensor through a pivot member longitudinal hole (450 as shown in FIG. 4) with the pivot member longitudinal hole being formed by the pivot member housing through hole (412 as shown in FIG. 4) and the sensor housing through hole (422 as shown in FIG. 4).

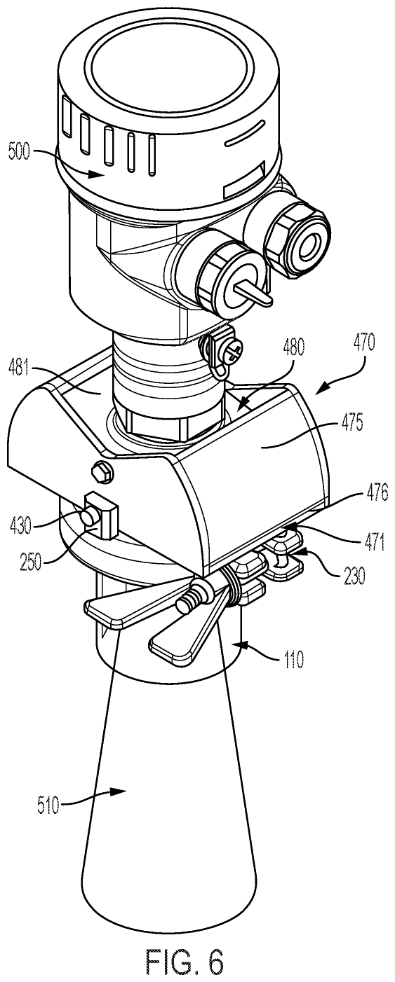

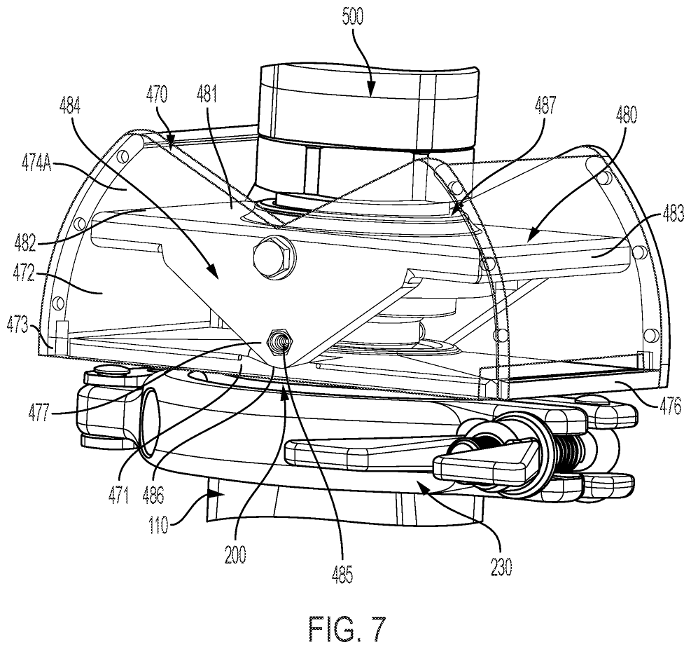

Another embodiment of the apparatus is shown in FIG. 6 through FIG. 8. This second embodiment of the apparatus shown comprises an apparatus base (200 as shown in FIG. 7) and a pivot member (400).

Like the embodiment shown in FIG. 3 through FIG. 5, in the embodiment shown in FIG. 6 through FIG. 8, the apparatus base (200 as shown in FIG. 7) will be configured to connect to the vessel connection (110). The connection between the vessel connection and the apparatus base may take many forms. In some embodiments, the connection between the vessel connection and the apparatus base may comprise the use of at least one fastener such as a clamp, a screw, a bolt, and combinations thereof. Often a first gasket will be located at an interface between the apparatus base and the vessel connection to improve sealing between the vessel connection and the apparatus base.

In some embodiments, the apparatus base (200) may be a process flow sight glass. One example of such a process flow sight glass-which forms an aseptic seal with the vessel connection—is disclosed in U.S. Pat. No. 10,914,910 B2—the teachings of which are incorporated by reference herein in their entirety. As discussed in U.S. Pat. No. 10,914,910 B2, the process flow sight glass may be connected to the vessel connection by way of a clamp (230) of the type disclosed in U.S. Pat. No. 10,914,910 B2.

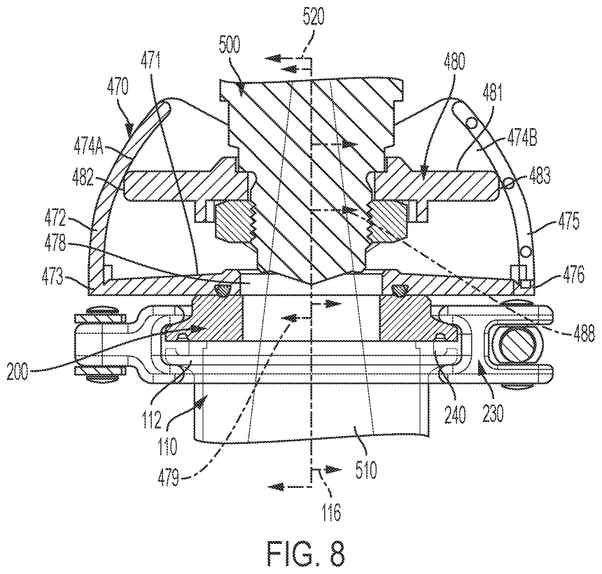

Notably, the embodiment shown in FIG. 6 through FIG. 8 may not comprise a separate rotation member such as in the embodiment shown in FIG. 3 through FIG. 5. However, the sensor (500) in the embodiment shown in FIG. 6 through FIG. 8 may still be rotated by several means. In some embodiments, the sensor may be rotated within the sensor casing (480) to adjust the incident beam line (520 as shown in FIG. 8). In other embodiments, the entire apparatus may be rotated-thereby rotating the sensor—by loosening the connection between the apparatus base (200 as shown in FIG. 7) and the vessel connection (110) and rotating the entire apparatus-including the sensor—to adjust the incident beam line.

FIG. 6 also shows the pivot member (400). As shown in FIG. 6, the pivot member comprises a pivot member casing (470) and a sensor casing (480). In general, the pivot member casing will be configured to encompass the sensor casing with the sensor casing residing within a hollow interior of the pivot member casing.

As shown in FIG. 6 to FIG. 8, the pivot member casing (470) may comprise a bottom wall (471) having a bottom wall first edge (473) and a bottom wall second edge (476). Extending upwardly from the bottom wall first edge may be a first side wall (472). Preferably, the first side wall will have a first concave interior surface (474A) which-once assembled with the casing housing (480)—interacts with a first edge (482) of the sensor casing planar member (481) as described herein. Similarly, a second side wall (475) may extend upwardly from the bottom wall second edge. Preferably, the second side wall will have a second concave interior surface (474B) which-once assembled with the casing housing-interacts with a second edge (483) of the sensor casing planar member (481) as described herein. A pivot member casing through hole (478 as shown in FIG. 7) may pass through a pivot member casing longitudinal axis (479 as shown in FIG. 7) allowing at least a portion of the sensor (500) to reside within the pivot member casing.

The pivot member casing (470) will also have a pivot member casing mounting hole (477 as shown in FIG. 7). Preferably the pivot member casing mounting hole will be located within the hollow interior of the pivot member casing along the bottom wall. The pivot member casing will be substantially parallel or parallel with the bottom wall first edge (473) and the bottom wall second edge (476). When assembled as described herein, the pivot member casing mounting hole serves as a connection point between the pivot member casing and the sensor casing (480) and also forms—in conjunction with a third fastener (430) and the sensor casing mounting hole (485 as shown in FIG. 7)—a pivot point allowing the sensor casing to pivot within the pivot member casing.

FIG. 6 also shows the sensor casing (480). As shown in FIG. 6, the sensor casing may comprise a sensor casing planar member (481) having at least a first edge (482) and a second edge (483) which is opposite the first edge. When assembled into a pivot member (400), the first edge interacts with the first concave interior surface (474A) of the pivot member casing (470) while the second edge interacts with the second concave interior surface (474B) of the pivot member casing.

The sensor casing (480) may also comprise a sensor casing extension (484) which—in general—extends away from a bottom surface of the sensor casing planar member (481). While the sensor casing extension may take many forms, the preferred form for the sensor casing extension is a triangular shape such as shown in FIG. 6. A sensor casing through hole (487 as shown in FIG. 7) may pass through a sensor casing longitudinal axis (488 as shown in FIG. 7) allowing at least a portion of the sensor (500) to reside within the sensor casing.

The sensor casing extension (484) will have a tip (486). As shown in FIG. 6, a sensor casing mounting hole (485 as shown in FIG. 7) may pass through the tip of the sensor casing extension. When assembled as described herein, the sensor casing mounting hole serves as a connection point between the pivot member casing (470) and the sensor casing and also forms—in conjunction with a third fastener (430) and the pivot member casing mounting hole (477 as shown in FIG. 7)—a pivot point allowing the sensor casing to pivot within the pivot member casing.

Each third fastener (430) may also pass through a stud (250 as shown in FIG. 6) which extends from a top surface of the clamp (230). Preferably the stud will be integrally connected to the clamp such as by welding the stud to the top surface of the clamp or by manufacturing the stud and the clamp of a single integral piece of material. In some embodiments there will be two studs—preferably located on opposing sides of the clamp. The pivot member casing (470) may be configured to fit between the studs with the third fastener(s) connecting the pivot member casing to the clamp as shown in FIG. 6.

FIG. 6 through FIG. 8 also show the sensor casing (480) which may be configured to connect to the pivot member casing (470) by passing a third fastener (430) through the pivot member casing mounting hole (477) and the sensor casing mounting hole (485). Each third fastener may individually be selected from the group of fasteners consisting of a bolt, a screw, a rivet, and the like. In some embodiments, each third fastener may include an O-ring, gasket, or other sealing member. The connection between the sensor casing and the pivot member casing creates a pivot point allowing the sensor casing to pivot within the pivot member casing.

Once assembled, the sensor (500) may be connected to the apparatus as shown in FIG. 8. The sensor may be connected to the apparatus by passing a portion of the sensor through a pivot member longitudinal hole (450 as shown in FIG. 7) with the pivot member longitudinal hole being formed by the pivot member casing through hole (478 as shown in FIG. 7) and the sensor casing through hole (487 as shown in FIG. 7).

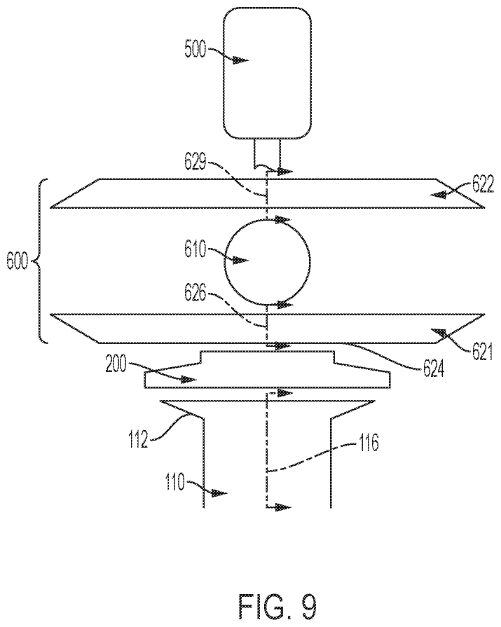

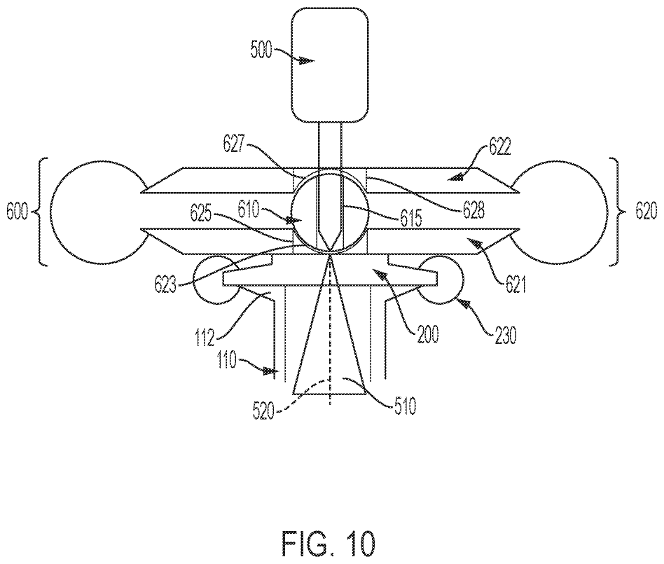

Another embodiment of the apparatus is shown in FIG. 9 and FIG. 10. This third embodiment of the apparatus shown comprises an apparatus base (200 as shown in FIG. 9) and an axis adjustment member (600).

Like the embodiment shown in FIG. 3 through FIG. 5 and the embodiment shown in FIG. 6 through FIG. 8, in the embodiment shown in FIG. 9 and FIG. 10, the apparatus base (200 as shown in FIG. 9) will be configured to connect to the vessel connection (110). The connection between the vessel connection and the apparatus base may take many forms. In some embodiments, the connection between the vessel connection and the apparatus base may comprise the use of at least one fastener such as a clamp, a screw, a bolt, and combinations thereof. Often a first gasket will be located at an interface between the apparatus base and the vessel connection to improve sealing between the vessel connection and the apparatus base.

In some embodiments, the apparatus base (200) may be a process flow sight glass. One example of such a process flow sight glass—which forms an aseptic seal with the vessel connection—is disclosed in U.S. Pat. No. 10,914,910 B2—the teachings of which are incorporated by reference herein in their entirety. As discussed in U.S. Pat. No. 10,914,910 B2, the process flow sight glass may be connected to the vessel connection by way of a clamp (230) of the type disclosed in U.S. Pat. No. 10,914,910 B2.

Notably, the embodiment shown in FIG. 9 and FIG. 10—like the embodiment shown in FIG. 6 through FIG. 8—may not comprise a separate rotation member such as in the embodiment shown in FIG. 3 through FIG. 5. However, the sensor (500) in the embodiment shown in FIG. 9 and FIG. 10 may still be rotated by several means. In some embodiments, the sensor may be rotated within the ball (610) of the axis adjustment member (610) to adjust the incident beam line (520 as shown in FIG. 10). In other embodiments, the ball itself may be rotated within the mounting clamp (620) to adjust the incident beam line.

FIG. 9 also shows the axis adjustment member (600). As shown in FIG. 9, the axis adjustment member may comprise a ball (610) and a mounting clamp (620). The ball may comprise an axial through hole (615 as shown in FIG. 10) within which at least a portion of the sensor (500) resides when the apparatus is assembled as shown in FIG. 10.

The mounting clamp (620) may comprise a first mounting clamp section (621) and a second mounting clamp section (622). Each mounting clamp section may have a concave surface at the interior thereof surrounding a mounting clamp section through hole around the respective mounting clamp section longitudinal axis. That is to say that the first mounting clamp section has a first concave surface (623) and a first mounting clamp section through hole (625) around a first mounting clamp section longitudinal axis (626). Similarly, the second mounting clamp section has a second concave surface (627) and a second mounting clamp section through hole (628) around a second mounting clamp section longitudinal axis (629).

In operation, the ball (610) resides within an interior of the mounting clamp (620) formed by the first concave surface (623) and the second concave surface (627). This configuration allows the sensor—at least a portion of which resides within the axial through hole (615) of the ball (610)—to pivot from the vessel connection longitudinal axis (116 as shown in FIG. 9) and to rotate about the vessel connection longitudinal axis.

The first mounting clamp section (621) may also have a first mounting clamp section mounting surface (624) as shown in FIG. 9 with the first mounting clamp section mounting surface located on a side of the first mounting clamp section opposite the first concave surface (623). When assembled, the axis adjustment member (600) is configured to connect to the apparatus base (200) with the first mounting clamp section mounting surface abutting against a planar surface of the apparatus base as shown in FIG. 9 and FIG. 10. In some embodiments, a faster such as a bolt, screw, rivet, clamp, or the like may assist in connecting the axis adjustment member to the apparatus base. Preferably, a fourth gasket will be located at an interface between the first mounting clamp section mounting surface and the apparatus base when the axis adjustment member is connected to the apparatus base.

By allowing the incident beam line to pivot from the vessel connection longitudinal axis and to further rotate about the vessel connection longitudinal axis, the incident beam line—and therefore the incident beam itself—may be adjusted to coincide with the vessel outlet connection longitudinal axis as shown in FIG. 2. Such adjustments may allow an operator to measure and monitor the liquid level within the vessel at the vessel outlet connection more accurately—pa when the vessel has a conical, concave, or otherwise angled/sloped bottom wall. By mounting the sensor—or radar level measurement device—to the apparatus base—which may be a process flow sight glass—the incident beam line may be pivoted and rotated while still maintaining sealing between the various components including aseptic sealing between the apparatus base and the vessel connection.

Also developed was the use of markings on the side of the swivel to indicate the angle of tilt away from the vertical.

Precision of the setting may be accomplished by inserting a laser in the range of visible light (380-720 nm) into the sensor housing through hole so that the laser light is coincident with the sensor housing longitudinal axis. This allows the laser light to point to the exact spot the incident beam line will strike the vessel or vessel outlet.

Unless the laser is configured exactly as the radar, the laser will require a housing adapter to adapt it fix it within the housing coincident with the sensor housing longitudinal axis. Once fixed within the housing, the laser light can be adjusted to tilt away from the vertical and rotate about the vessel connection until the laser light strikes the desired point on the vessel wall which includes the bottom dome. The apparatus is then set, the laser and adapter removed, and the radar placed into the housing.

In this manner the radar can be installed in a precise manner instead of the multiple modes of “guess and check”.

Experiments also determined that the effectiveness of the non-contact radar system became highly dependent upon the type of material used between the radar and the inside of the vessel.

### EXPERIMENTAL

The benefit of angling the incident beam was established by measuring the various liquid levels at differing angles from the vertical longitudinal axis of the vessel.

In this case the vessel was 24 inches/(61 cm) in diameter with the round section being 26 inches/(66 cm) in height. The vessel had a top dome and a bottom dome, each dome having a 5 inch/(12.7 cm) height making the vessel 36 inches/(91.4 cm) in total height. The vessel outlet port was located at the longitudinal axis. The center of the round vessel connection was 4 inches/(10.2 cm) from the wall and accordingly, 8 inches/(10.3 cm) from the center of outlet port.

Mathematically the angle formed by the line intersecting the vessel outlet connection longitudinal axis and the vessel connection and the vessel connection longitudinal axis is 12 Degrees [Ø=Sin⁻¹(8/38)=12].

The vessel was filled with liquids at different heights measured by a pressure transducer located past the vessel outlet.

Each level was measured by the same radar tilted at 0, 3, 6, and 8 degree angles.

The difference between the raw data and the accurate control level is shown in Table 1 below.

| Height from | |
|---|---|
| Bottom | DEGREES FROM VERTICAL |

| Inches of Water | 8 | 6 | 3 | 0 |
|---|---|---|---|---|
| 0.00 | 0.05 | −0.06 | 1.27 | 1.45 |
| 0.05 | −0.13 | −0.15 | −0.30 | −0.08 |
| 0.10 | −0.22 | −0.06 | −0.38 | 1.68 |
| 0.15 | −0.02 | 0.01 | 0.10 | 0.11 |
| 0.20 | −0.34 | −0.41 | −0.45 | −0.37 |
| 0.25 | −0.47 | −0.44 | −0.25 | −0.43 |
| 0.30 | −0.06 | −0.05 | 0.02 | 0.08 |
| 0.35 | −0.15 | −0.08 | −0.12 | 0.06 |
| 0.40 | −0.17 | −0.18 | −0.19 | −0.05 |
| 0.45 | −0.10 | −0.59 | −0.01 | 0.11 |
| 0.50 | −0.13 | −0.12 | −0.21 | 1.10 |
| 0.55 | −0.08 | −0.07 | 0.07 | 0.24 |
| 0.60 | −0.01 | 0.11 | 0.31 | 0.60 |
| 0.65 | 0.13 | 0.16 | 0.24 | 0.39 |
| 0.70 | 0.08 | 0.07 | 0.16 | 0.15 |
| 0.75 | −0.04 | −0.04 | 0.02 | 0.00 |
| 0.80 | −0.13 | −0.11 | −0.09 | −0.07 |
| 0.85 | 0.04 | 0.05 | 0.10 | 0.13 |
| 0.90 | 0.02 | 0.02 | 0.05 | 0.07 |
| 0.95 | −0.06 | −0.08 | −0.07 | −0.09 |
| 1.00 | −0.03 | −0.03 | −0.03 | −0.04 |
| 1.05 | −0.02 | −0.02 | 0.00 | 0.01 |
| 1.10 | −0.02 | −0.04 | −0.04 | 0.02 |
| 1.15 | −0.03 | −0.02 | 0.01 | 0.02 |
| 1.20 | 0.01 | 0.00 | 0.01 | 0.02 |
| 1.25 | −0.02 | −0.04 | −0.02 | −0.01 |
| 1.30 | 0.00 | −0.01 | 0.00 | −0.01 |
| 1.50 | 0.00 | −0.02 | 0.00 | 0.03 |
| 1.75 | −0.03 | −0.04 | −0.04 | −0.04 |
| 2.00 | −0.02 | −0.02 | 0.02 | 0.05 |
| 2.25 | −0.03 | −0.03 | 0.00 | −0.03 |
| 2.50 | −0.03 | −0.03 | −0.03 | −0.05 |
| 2.75 | −0.01 | −0.03 | −0.03 | −0.04 |
| 3.00 | −0.02 | 0.02 | −0.05 | −0.07 |

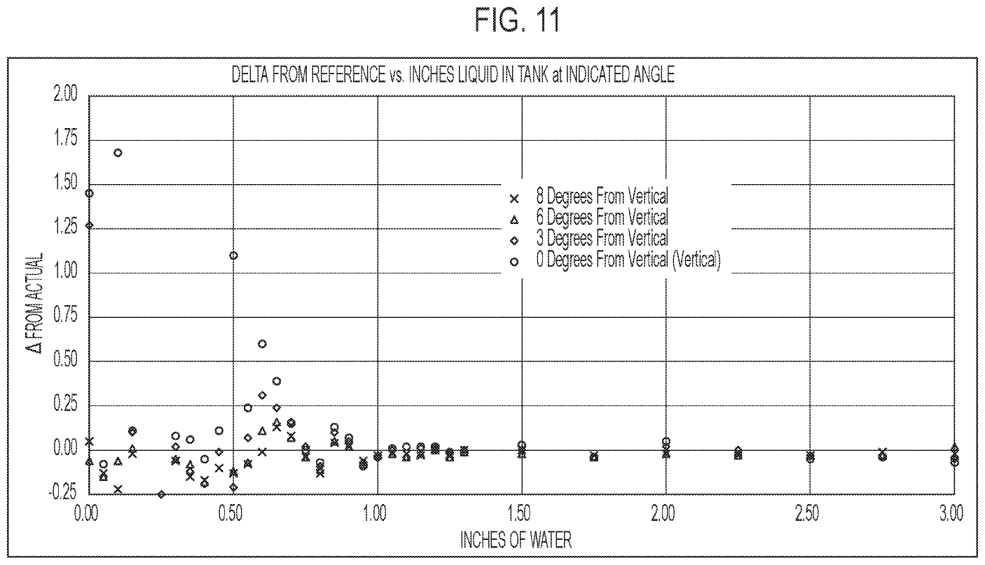

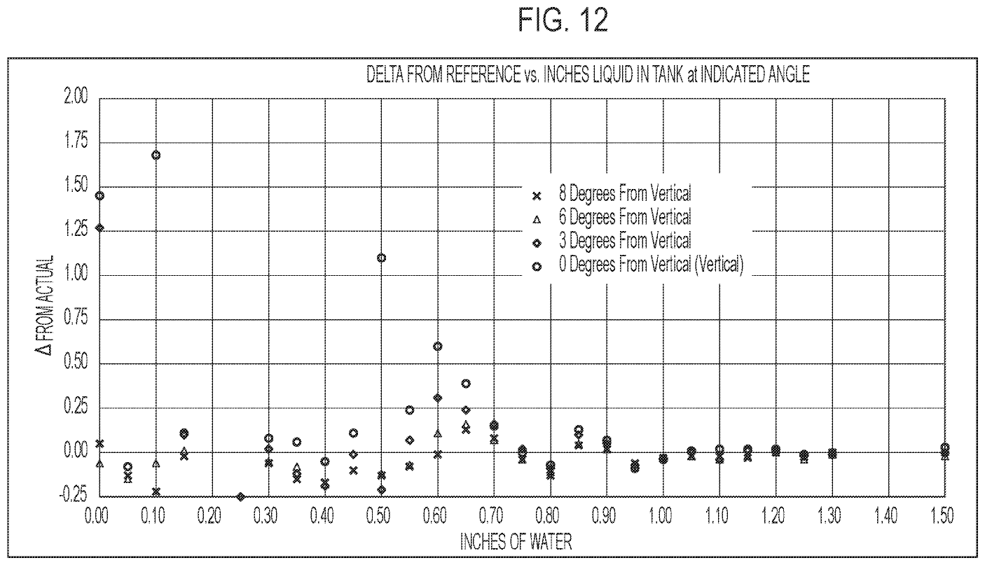

This data is plotted in FIGS. 11 and 12. FIG. 11 shows the data for liquid levels up to 3.0 inches. As seen, as the relative differences for the acute angles converge to 0 as the liquid level gets higher. This can be visualized as the liquid level rises in the dome, it spreads closer to the walls of the vessel and becomes more readable by radar with little or no acute angle.

FIG. 12 is an exploded view shows a significant amount of deviation from and the actual reading. However, as seen in the table and FIG. 12, the greater the acute angle, the better the accuracy.

The experimental does not report 12 degrees, at the point of intersection because it was not as accurate as the 8 degree acute angle. However 12 degrees was more accurate than the vertical or 0 degree. It was later learned that some radar beams may not be the strongest at the center, may be stronger somewhere between 0 degrees and the angle of intersection.

1. (canceled)

2. (canceled)

3. An apparatus for measuring a liquid level above a vessel outlet connection (120) located on an outlet side of a vessel (100) having a vessel outlet connection longitudinal axis (125) with a sensor (500) that emits an incident beam (510) of electromagnetic which forms an incident beam line (520), said apparatus comprising:
an apparatus base (200) configured to connect to the vessel connection;
a rotation member (300) comprising an incident beam hole (310), at least one rotation member mounting hole (320), and at least one rotation member curvilinear slot (330); and
a pivot member (400) comprising:
a pivot member housing (410) comprising a first hemispherical exterior profile (411), a pivot member housing through hole (412) around a pivot member housing longitudinal axis (413), at least one pivot member housing longitudinal mounting hole (414), at least one pivot member housing radial mounting hole (415), and at least one pivot member housing curvilinear slot (416); and
a sensor housing (420) comprising a second hemispherical exterior profile (421), a sensor housing through hole (422) around a sensor housing longitudinal axis (423), and at least a sensor housing first mounting hole (424) and a sensor housing second mounting hole (425);
wherein the apparatus is configured to allow the incident beam line to pivot +/−30 degrees from the vessel connection longitudinal axis forming a first angle relative to the vessel connection longitudinal axis, and the apparatus is configured so that the incident beam line can be rotated about the vessel connection longitudinal axis;
wherein the rotation member is configured to connect to the apparatus base by passing a first fastener (210) through the at least one rotation member mounting hole and into at least one apparatus base mounting hole (220);
wherein the pivot member housing is configured to connect to the rotation member by passing a second fastener (340) through the at least one pivot member housing longitudinal mounting hole and the at least one rotation member curvilinear slot;
wherein the pivot member housing is configured to connect to the sensor housing by passing a third fastener (430) through the pivot member housing radial mounting hole and into the sensor housing first mounting hole, and passing a fourth fastener (440) through the pivot member housing curvilinear slot and into the sensor housing second mounting hole;
wherein a hemispherical interior profile of the pivot member housing is configured to interface with the second hemispherical exterior profile; and
wherein the sensor is configured to reside at least partially within a pivot member longitudinal hole (450) formed by the pivot member housing through hole and the sensor housing through hole.

4. The apparatus of claim 3, wherein the apparatus base is configured to connect to the vessel connection (110) by a clamp (230).

5. The apparatus of claim 3, further comprising a first gasket (240) configured to locate at an interface between the apparatus base and the vessel connection.

6. The apparatus of claim 3, wherein the apparatus base is a process flow sight glass.

7. The apparatus of claim 3, further comprising a second gasket (350) configured to locate at an interface between the rotation member and the apparatus base.

8. The apparatus of claim 3, further comprising a third gasket (460) located at an interface between the pivot member and the rotation member.

9. An apparatus for measuring a liquid level above a vessel outlet connection (120) located on an outlet side of a vessel (100) having a vessel outlet connection longitudinal axis (125) with a sensor (500) that emits an incident beam (510) of electromagnetic which forms an incident beam line (520), said apparatus comprising:
an apparatus base (200) configured to connect to the vessel connection; and
a pivot member (400) comprising:
a pivot member casing (470) comprising a bottom wall (471), a first side wall (472) extending upwardly from a bottom wall first edge (473) and having a first concave interior surface (474A), a second side wall (475) extending upwardly from a bottom wall second edge (476) opposite the bottom wall first edge and having a second concave interior surface (474B), a pivot member casing mounting hole (477) parallel with the bottom wall first edge and the bottom wall second edge, and a pivot member casing through hole (478) around a pivot member casing longitudinal axis (479); and
a sensor casing (480) comprising a sensor casing planar member (481) having at least a first edge (482) and a second edge (483), a sensor casing extension (484), a sensor casing mounting hole (485) passing through a tip (486) of the sensor casing extension, and a sensor casing through hole (487) around a sensor casing longitudinal axis (488); and
wherein the apparatus is configured to allow the incident beam line to pivot +/−30 degrees from the vessel connection longitudinal axis forming a first angle relative to the vessel connection longitudinal axis, and the apparatus is configured so that the incident beam line can be rotated about the vessel connection longitudinal axis;
wherein the apparatus base comprises a clamp (230) having at least one stud (250) extending from a clamp top surface;
wherein the pivot member casing is configured to connect to the apparatus base by passing a third fastener (430) through the stud and the sensor casing mounting hole;
wherein the sensor casing is configured to connect to the pivot member casing by passing the third fastener through the pivot member casing mounting hole and the sensor casing mounting hole;
wherein the first concave interior surface is configured to interact with the first edge;
wherein the second concave interior surface is configured to interact with the second edge; and
wherein the sensor is configured to reside at least partially within a pivot member longitudinal hole (450) formed by the pivot member casing through hole and the sensor casing through hole.

10. The apparatus of claim 9, wherein the apparatus base is configured to connect to the vessel connection (110) by a clamp (230).

11. The apparatus of claim 9, further comprising a first gasket (240) configured to locate at an interface between the apparatus base and the vessel connection.

12. The apparatus of claim 9, wherein the apparatus base is a process flow sight glass.

13. The apparatus of claim 9, further comprising a fourth gasket configured to locate at an interface between the pivot member casing and the apparatus base.

14. The apparatus of claim 9, wherein the sensor casing extension has a substantially triangular shape.

15. An apparatus for measuring a liquid level above a vessel outlet connection (120) located on an outlet side of a vessel (100) having a vessel outlet connection longitudinal axis (125) with a sensor (500) that emits an incident beam (510) of electromagnetic which forms an incident beam line (520), said apparatus comprising:
an apparatus base (200) configured to connect to the vessel connection; and
an axis adjustment member (600) comprising:
a ball (610) having an axial through hole (615); and
a mounting clamp (620) comprising:
a first mounting clamp section (621) having a first concave surface (623), a first mounting clamp section mounting surface (624), and a first mounting clamp section through hole (625) around a first mounting clamp section longitudinal axis (626); and
a second mounting clamp section (622) having a second concave surface (627), and a second mounting clamp section through hole (628) around a second mounting clamp section longitudinal axis (629); and
wherein the apparatus is configured to allow the incident beam line to pivot +/−30 degrees from the vessel connection longitudinal axis forming a first angle relative to the vessel connection longitudinal axis, and the apparatus is configured so that the incident beam line can be rotated about the vessel connection longitudinal axis;
wherein the axis adjustment member is configured to connect to the apparatus base with the first mounting clamp section mounting surface abutting against a planar surface of the apparatus base;
wherein the ball is configured to reside within an interior of the mounting clamp formed by the first concave surface and the second concave surface; and
wherein the sensor is configured to reside at least partially within the axial through hole.

16. The apparatus of claim 15, wherein the apparatus base is configured to connect to the vessel connection by a clamp (230).

17. The apparatus of claim 15, further comprising a first gasket configured to locate at an interface between the apparatus base and the vessel connection.

18. The apparatus of claim 15, wherein the apparatus base is a process flow sight glass.

19. The apparatus of claim 15, further comprising a fourth gasket configured to locate at an interface between the first mounting clamp section mounting surface and the apparatus base.

20. The apparatus of claim 4, further comprising a first gasket (240) configured to locate at an interface between the apparatus base and the vessel connection.

21. The apparatus of claim 10, further comprising a first gasket (240) configured to locate at an interface between the apparatus base and the vessel connection.

22. The apparatus of claim 16, further comprising a first gasket (240) configured to locate at an interface between the apparatus base and the vessel connection.
